(19) United States
(12) Patent Application Publication
(10) Pub. No.: US 2009/0289524 A1
(43) Pub. Date: Nov. 26, 2009

(54) Colloid motor: a mechanical mechanism that harnesses colloid forces to serve as a memory, oscillator, or amplifier in the mechanical domain; a hair cell mimesis

(76) Inventor: Michelangelo Rossetto, New York, NY (US)

Correspondence Address: Michelangelo Rossetto, 125 W 86th St., New York, NY, 10024, US

(21) Appl. No.: 12/154,047

(22) Filed: May 21, 2008

(51) Int. Cl. H02N 1/00

(52) U.S. Cl. 310/309

(57) ABSTRACT

The colloid motor disclosed here is a method of using the colloid forces between two particles that arise from the interaction of Van der Walls attraction and electrostatic repulsion when the distance between them is measured in, at most, tens of nanometers. By applying a mechanical limit to the allowable distance between colloid elements it is possible to realize a bistable memory device. And if an offset force is added it is possible to realize a device that can function both as an amplifier and an oscillator in the mechanical domain, much as the tunnel diode functions in the electronic domain

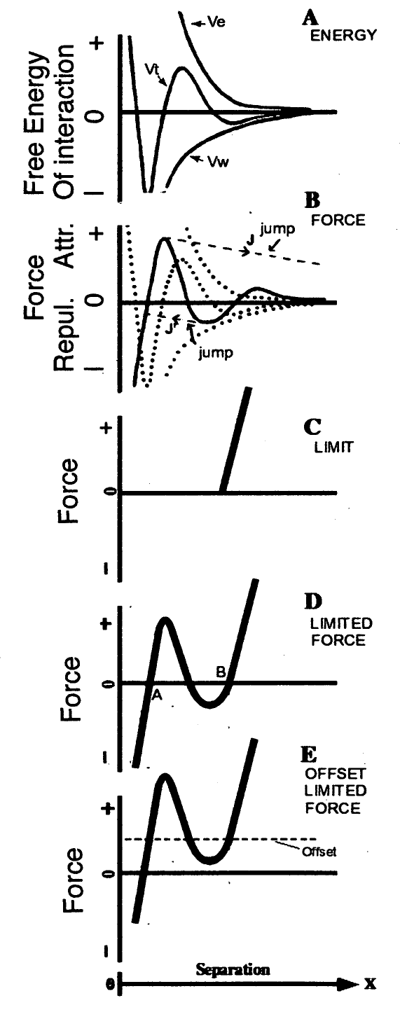

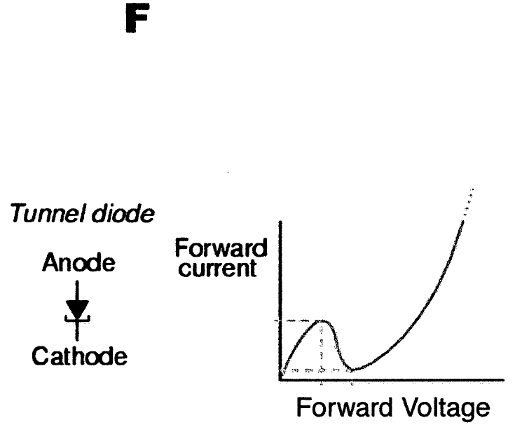

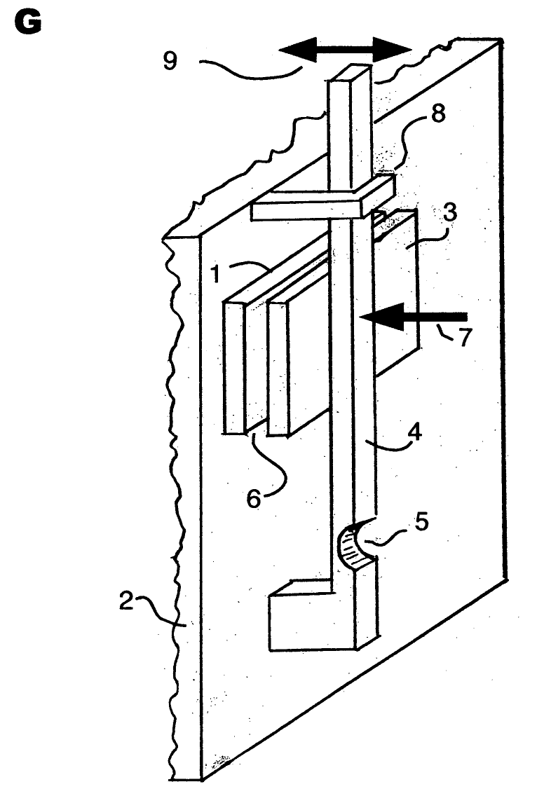

### BACKGROUND OF THE INVENTION

The colloid motor is of interest to the field of nanotechnology since it deals with forces and motions that span at most tens of nanometers.

This invention fills a need in the mechanical domain for a device that mimics well developed functions of the tunnel diode in the electronic domain. There is no device at present that can considered an active element in the realization of nanoscaled mechanical memory elements or nanoscaled mechanical amplifiers or oscilators.

Background on colloid theory pertinent to this invention can be found in: M. Rossetto, Colloids and Surfaces B 29 (2003) 257-263. and in the references in that paper.

It was the study of hair cell cilia that fertilized thinking on how it might be possible to fabricate an active colloid motor. The cilia are close enough to each other to experience colloid forces. They are tied to each other with tip links and side links that limit their separation. And finely they are pressed on by a Kinocilium that is able to provide a constant force. The marriage of these three functions, nanoscale seperation of elements, mechanical limiting of interelement spacing, and an applied external force, all of which can be realized using the technology of the semiconductor fabricators, makes possible the fabrication of a colloid motor.

### BRIEF SUMMERY OF THE INVENTION

The colloid motor can be summarized by comparing it to the tunnel diode. The tunnel diode has a negative resistance region in its characteristic curve which allows it to function as a memory element, an amplifier, and an oscillator in the electronic domain. The colloid motor described in this invention achieves a negative sloped area in its force/displacement curve through the application of an appropriate limit function and a constant force that offsets the curve that describes the colloid forces of two closely opposed colloid elements. This negative sloped part of the curve allows for behavior in the mechanical domain, just as the negative slope of the tunnel diode allows for bi-stability, amplification, and oscillation in the electronic domain.

### DETAILED DESCRIPTION OF THE INVENTION

Figures A through E describe the colloid forces and the effect of the applied limit function and offset function that result in the realization of a colloid motor.

### FIGURE A

Figure A is a summery of basic colloid theory showing the free energy of interaction Vt that results from the combined Van der Walls attraction, Vw, and the electrostatic repulsion, Ve, experienced by adjacent colloid particles. The Van der Walls force is the-consequence of the attraction of molecular dipoles in adjacent particles. The electrostatic repulsion, Ve arises when the orbital electrons of adjacent particles get close enough to feel each other. The abscissa, X, represents the distance between the colloid particles. Contact, or zero distance, is at the left of the figure.

Both the Van der Waals attractive and the electrostatic repulsive forces are inverse power functions with different exponents in the energy domain. The van der wall forces are positive, the electrostatic forces are negative. Their interaction is equivalent to a subtraction of two similar, large numbers, a process that emphasizes small differences. In this case it is the subtraction of the differing ripples produced by the two inverse power functions that results in the complex shape of the the energy function Vt of Fig A.

### FIGURE B

Figure B is the slope of the energy curve Vt, dV/dX, which is the force experienced by adjacent colloid particles a function of separation (X). At the energy minimum of fig A the force curve shows a stable resting place where the colloid particles experience neither repulsion or attraction. The jumps J and J′ represent instabilities that have been observed-when colloid particles are moved toward or away from each other. These jumps are the basis for the realization of a memory function.

### FIGURE C

Figure C shows the behavior of a mechanical limit or stop. It is like the behavior of a rope that ties a boat to a dock. When the rope is slack there is no force in the rope. When the boat moves away from the,dock the rope reaches its limit and becomes tense. The swiffly rising curve limits how far apart the colloid elements are to each other.

### FIGURE D

Figure D shows the combined interaction of the colloid force/function and the limit function showing how the resulting combined function has the same form as the tunnel diode function shown in Figure F. The points ‘A’ and ‘B’ are the two stable points that represent the two states of the device when it is used as a memory

### FIGURE E

Figure E shows how the curve of Figure D is shifted into the first quadrant by the application of a constant force bias. The curve is now analogous to the tunnel diode curve which lies completely in the first quadrant

### FIGURE F

Figure F shows the characteristic curve of a typical tunnel diode. It is this curve that is mimicked by the limiting and offsetting of the colloid force function. The negative sloped portion of the tunnel diode is the characteristic that allows it to be used as a memory element, amplifier and oscillator. The energy for amplification and oscillation is provided by the DC bias that sets an operating point in the negative slope region. The steady offset force in the colloid motor will similarly provide a source of energy.

### FIGURE G

Figure G is a schematic example of how a colloid motor can be realized

This drawing shows how one of the two colloid elements is mounted solidly on a block of material. This could be, for example, silicon if semiconductor fabrication technology is used to realize the device. The second colloid element is mounted on a beam that has been thinned to flexibility to allow the distance between the two colloid elements to change. This mounting method is schematically illustrative. The mounting method applied to the movable colloid element must: provide alignment to the movable colloid element; provide a means of applying an offset force if required; allow the application of a mechanical limit; and finely provide a means of coupling the motion of the movable colloid element to its application.

The motion between the colloid elements is limited by the mechanical limit It limits the maximum distance allowed between the colloid elements

The motion output may be taken, as shown, on the support of the movable colloid element, or it may be taken on any part of the movable structure. For example it may be taken on the movable colloid element itself.

The applied offset force that is necessary for the amplifier or oscillator applications may be applied, as shown, directly to the movable colloid element, or to any part of the structure that supports the movable colloid element. One possible way of applying the offset force would be to apply an electric field between the two colloid elements.

1. The colloid motor presented in this claim is a mechanical device that uses the interaction of Van der walls attraction and the electrostatic repulsion of closely apposed colloid particles. The distance between the colloid elements is limited to restrict the colloid force function to have a shape similar to the volt/amp function of the tunnel diode. This allows the device to act as a memory element The state of the memory can be observed by noting the distance between the two colloid elements or by observing the capacity between the colloid elements, which will indicate the distance between the elements. When to the limit function there is added a force that presses the colloid elements toward each other, the active part of the limited colloid function is raised into the first quadrant and it now mimics the operating curve of the tunnel diode. It can now be expected to find applications in the mechanical domain, such as amplification and oscillation, that are found with the tunnel diode in the electronic domain.
